(19) United States
(12) Patent Application Publication
(10) Pub. No.: US 2012/0022929 A1
(43) Pub. Date: Jan. 26, 2012

(54) ELECTRONIC COUPON SYSTEM

(76) Inventors: Mark Raymond, South Park, PA (US); Michael S. Wagner, South Park, PA (US)

(21) Appl. No.: 13/270,474

(22) Filed: Oct. 11, 2011

Related U.S. Application Data
(63) Continuation-in-part of application No. PCT/US2011/001191, filed on Jul. 7, 2011.

(51) Int. Cl. G06Q 30/00

(52) U.S. Cl. 705/14.15

(57) ABSTRACT

Internet, web-based platform that offers low cost advertising venue for companies and a convenient shopping venue for customers. The system includes storage capacity to store information on purchased and redeemed coupons, and includes logic to analyze the effectiveness of a marketing campaign based on statistical analysis of redeemed coupons relative to purchased coupons. One embodiment includes a system capable of automatically comparing and analyzing the customers' stored preferences with posted coupons, and automatically sending a listing of coupons that match the customer's preference by email, text message, or by any commercially available communication mode. Another embodiment includes a coupon sales revenue sharing function between the web site and the matched coupon company that credits both the web site's account and the company's account for each coupon sold, where the company's shared revenue portion can be limited.

### CROSS REFERENCE TO RELATED APPLICATIONS

The present application is a Continuation In Part application of International Application Number PCT/US2011/001191, entitled ELECTRONIC COUPON SYSTEM filed on Jul. 7, 2011, which is incorporated herein by reference.

### FIELD OF THE INVENTION

The present invention is related generally to the internet marketing and sales of electronic coupons, and in particular to a process of the web site hosting company having an option to share a portion of the internet coupon sales with the company offering the coupon.

### BACKGROUND OF THE INVENTION

Current marketing technology ranges from coupons in entertainment books, ads in yellow page phone books, newspaper advertisements, magazine advertisements, and local direct mailings. These methods are all very expensive ways for small businesses to advertise their services and products.

### SUMMARY OF THE INVENTION

The present invention is an internet, web-based platform that offers a low cost advertising venue for companies and a convenient shopping venue for customers. Companies are provided an affordable, virtual marketing venue that rewards the company for creative coupon offers that entice customers to purchase coupons for a nominal fee and to patronize the company's establishment or use its services. Companies can target advertising in specific markets. Customers can find places and services of interest based on geographical location (for example, by area code or zip code) that offer discounts through the purchase of nominally priced coupons. The places and services of interest can be restaurants, theaters, amusement parks, museums, hotels, transportation, dry cleaners, etc.

The web site hosting company can charge a monthly subscription fee for: (i) the services of posting, promoting, and managing the coupon sales, (ii) distributing and tracking of the purchased coupons for marketing evaluation, and (iii) analyzing the effectiveness of a coupon-based marketing campaign based on statistical analysis of redeemed coupons relative to purchased coupons. The system includes storage capacity to store information on purchased and redeemed coupons, and includes logic to analyze the effectiveness of a marketing campaign based on statistical analysis of redeemed coupons relative to purchased coupons. Even if a customer does not buy the coupon, the customer will see the coupon ad for that company, which results in inexpensive or free advertising (depending on the number of coupons sold during the month) for the company. Companies have peace of mind because the chances of a customer actually purchasing a coupon and utilizing it are very high. The coupon purchase virtually ensures customers will solicit the coupon provider's business.

One embodiment of the present invention includes a system capable of automatically or periodically comparing and analyzing the customers' stored preferences with the posted coupons, and automatically or periodically sending a listing of coupons that match the customers' preference by email, text message, or by any commercially available communication mode. Automatic comparison and matches are generated either upon registration of a new customer or upon posting of a new coupon that meets the preference criterion of the customer.

One embodiment of the present invention includes a coupon sales revenue sharing feature that credits the company's account for each coupon sold up to an agreed upon limit or no limit. The credit can reduce or eliminate the company's future subscription fee, such as the next month's subscription fee. In the case where the limit is equivalent to the monthly subscription fee, the company's advertising is free. In the case where the limit is greater than the monthly subscription fee or no limit, the company makes money from the posting of the coupon and the internet, web-based platform of the present invention becomes a profit center for the company as well as free advertising venue.

### BRIEF DESCRIPTION OF THE DRAWINGS

For the present invention to be easily understood and readily practiced, the invention will now be described, for the purposes of illustration and not limitation, in conjunction with the following figures, wherein:

FIG. 1 is a schematic of the network of the present invention;

FIG. 2 is a flow diagram of the process for a company to register and join the web site, and the process for a registered company to post coupons according to one embodiment of the present invention;

FIG. 3 is a flow diagram of the process for a customer to register to join the internet, web-based platform, and the process for a registered customer to search and purchase posted coupons according to one embodiment of the present invention;

FIG. 4 is a flow diagram of the customer coupon purchasing process according to one embodiment of the present invention;

FIG. 5 is a flow diagram of the company account crediting process according to one embodiment of the present invention; and

FIG. 6 is a flow diagram of the logic process to analyze purchased and redeemed coupons according to one embodiment of the present invention.

### DETAILED DESCRIPTION OF THE INVENTION

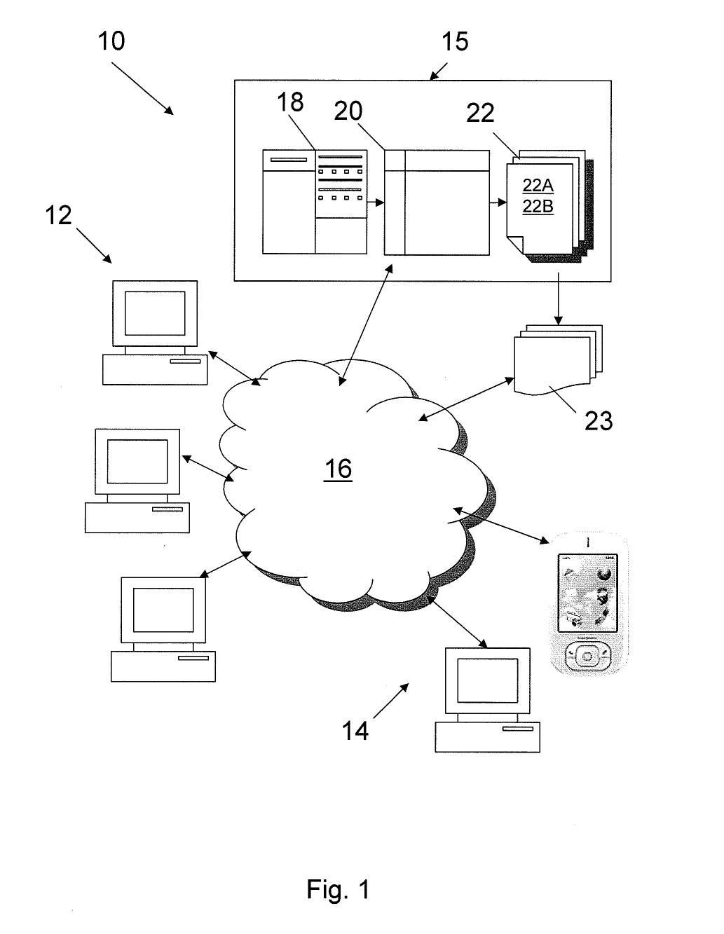

Now turning to FIG. 1 illustrating a schematic of one embodiment of the network 10 of the present invention. Network 10 includes companies 12 and customers 14 that link with internet, web-based platform (web site) 15 via the internet 16. Internet, web-based platform (web site) 15 includes web host server 18 in communication with storage device 20 that contains data base 22 of system files (coupon purchase data 22A and redeemed coupon data 22B) and logic.

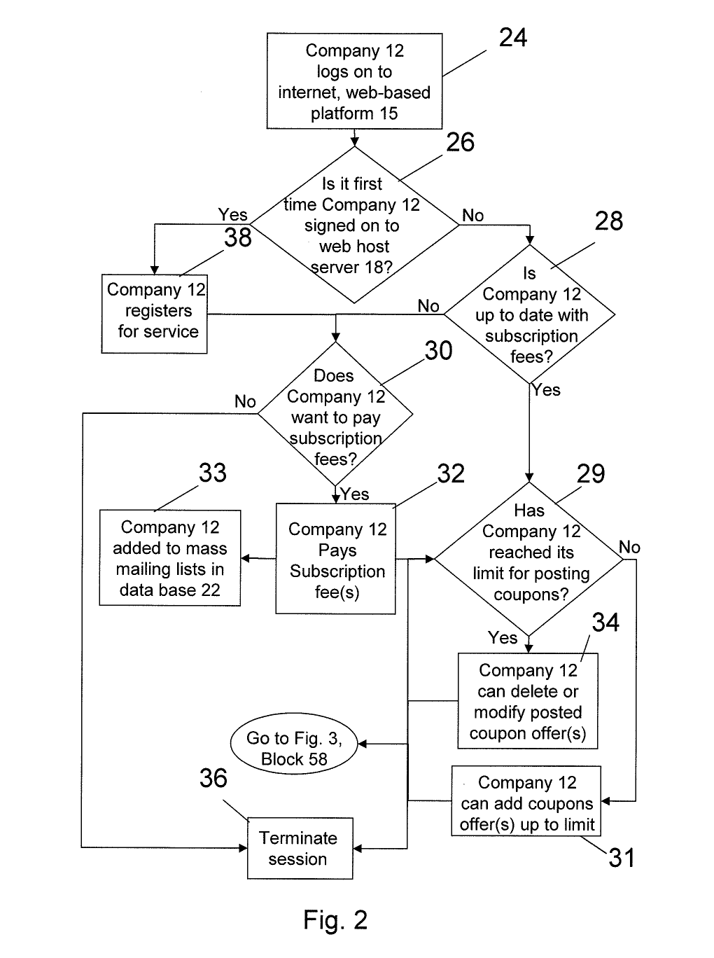

Now turning to FIG. 2 illustrating a flow diagram of the registration process for a company 12 to join the web site 15 of the present invention, and the process for a registered company 12 to post coupons according to one embodiment of the present invention. Company 12 logs on to web site 15 (Block 24). If it is the first time company 12 has signed on to web host server 18 (Block 26), then company 12 must register for service (Block 38) before being able to post coupons. Company 12 will provide information including but not limited to street address, city, state, zip code, type of business, and billing information. Company 12 can include surrounding zip codes in the search field such that customer 14 will receive the company's information along with similar companies in the particular zip code searched by customer 14. National business chains can download all store location zip codes.

Continuing with FIG. 2, a new company 12 must establish an account and pay the subscription fee of at least one month in advance (Block 32) prior to posting any coupons (Block 31), in a subscription fee is required. After registering, new and existing companies 12 can opt not to pay the subscription fee (Block 30) and terminate the session (Block 36). As long as an existing company 12 is up to date with its subscription fee (Block 28) or pays the outstanding balance of the subscription fee (Block 32), company 12 can add coupons (Block 31), or delete or modify coupon offers (Block 34). One embodiment of the present invention will have tier levels of subscription fees from a basic plan that limits the number of coupons posted per month (as few as one coupon per month up to a fixed number of coupons per month) to an unlimited plan that allows company 12 to post unlimited coupons. In the case where company 12 is allowed a limited number of postings (Block 29), then company 12 will only be allowed to delete or modify existing posting if company 12 has reached it limit of postings (Block 34). During a session, company 12 can make as many modifications, additions, or deletions providing that company 12 stays within the system and program parameters (such as payment of subscription fee and limited number of postings). Another embodiment of the present invention does not require any subscription fees for Company 12 to be a member of the web site. Company 12 can pay the subscription fee with any financial instrument or means, such as electronic funds transfer, electronic check, debit card, credit card, standard check, cash (if hand delivered to the web host's office), etc. Once company 12 is registered and posted coupons, the web site 15 will add company 12 to mass mailing listing in data base 22 (Block 33) that market web site 15 to potential customers 14 in defined areas to enhance web traffic.

Company 12 can limit or not limit the number of coupons sold, the value of the coupon, expiration period of the coupons, and other restrictions, such as the coupon is good for use only during certain times and days of the week, providing none of the restrictions violate local, state, and federal consumer protection laws, for which company 12 is fully and solely responsible for compliance therewith. Company 12 can post multiple specials and post pictures. The coupon can be printable or stored on a smart device in Point-Of-Sale compatible electronic format. The coupon can be uniquely number, bar coded, or include other commercially available tracking technology containing the date of sale, date of expiration (if any), and other indicia as necessary for tracking purposes.

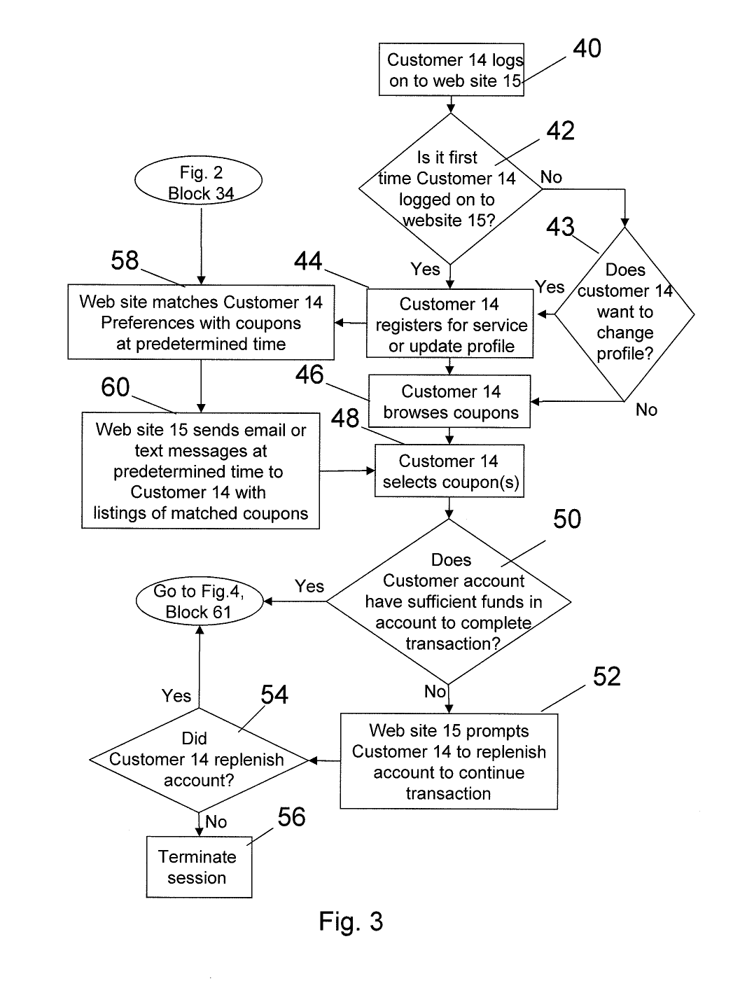

Now turning to FIG. 3 illustrating a flow diagram of the process for a customer 14 to register and join the web site 15, and the process for a registered customer 14 to search and purchase posted coupons according to one embodiment of the present invention. The process starts with customer 14 logging on to web site 15 (Block 40). If it is the first time customer 14 is logging on to web site 15 (Block 42), then customer 14 must register (Block 44). Customer 14 will provide email address, billing address, and form of payment of deposit money for the customer account. The deposited money can be fully refundable if no coupons are purchased under certain conditions. Customer 14 fills out an online profile of what type of coupons customer 14 is interested in to create a preference list of items based on location (such as area code, zip code, city, county, state, country, etc.) including but not limited to products, food cuisine, activities, amusements, entertainment, cultural events, sporting events, and other service venues. Web site 15 will match customer coupon preferences with posted coupons at a predetermined time, such as immediately, hourly, daily, weekly, monthly, etc. (Block 58) and send emails or text message to customer 14 listings of any coupon deals offered in those area's through web site 15 to customer 14 at a predetermined time, such as immediately, hourly, daily, weekly, monthly, etc., selected by customer 14 (Block 60). Customer 14 can also browse web site 15 for coupons (Block 46). Customer 14 can select a coupon to purchase (Block 48) either from the email or text message (Block 60) or coupons found when browsing (Block 46).

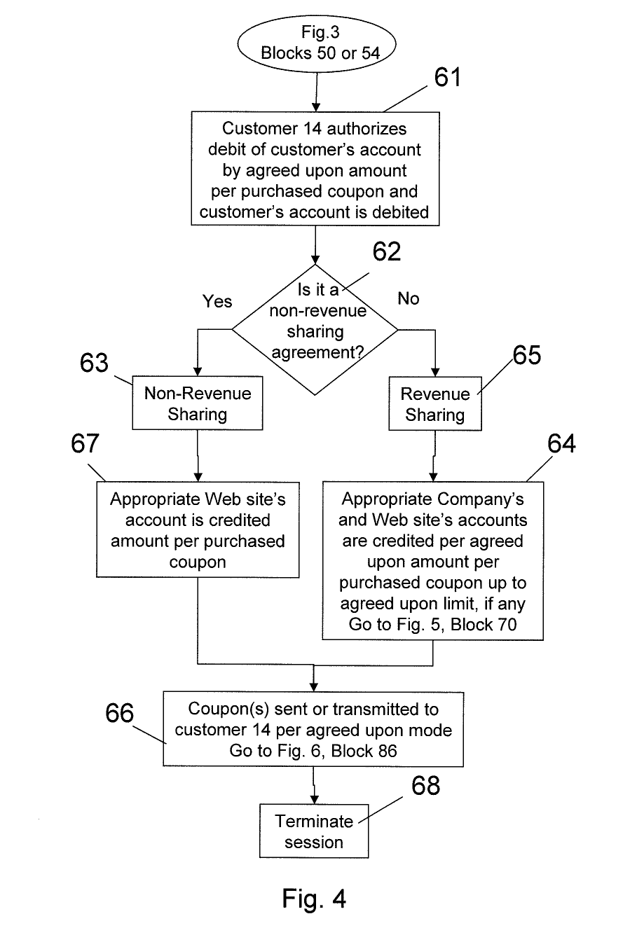

Continuing with FIG. 3, the present invention will verify that there is sufficient funds in the account for customer 14 to purchase coupons (Block 50). If there are not sufficient funds in the account to purchase the coupon, then a pop up screen will appear and prompt customer 14 to replenish the account to continue with the transaction (Block 52). If customer 14 does not replenish the account (Block 54), then the session is terminated (Block 56) and customer 14 can no longer participate on the web site 15 until the account is replenished. If customer 14 does replenish the account (Block 54) or there is sufficient funds in the account (Block 50), then the customer 14 authorizes the debit of the account by the agreed upon amount per coupon (for example, $0.50) and customer's account is debited (see FIG. 4, Block 61) accordingly.

Continuing with FIG. 4, once customer's account is debited by the purchase price of the coupon (Block 61), then the system determines (Block 62) whether the transaction is under a non-revenue sharing agreement (Block 63) or a revenue sharing agreement (Block 65) between web site 15 and matched coupon company 12. If the agreement is a non-revenue sharing, then the web site's account is credited the full purchase price of the coupon (Block 67). If the agreement is a revenue sharing agreement, then the debited amount can be shared between the web site 15 and matched coupon company 12 by an agreed upon portion of the coupon purchase price (for example, $0.50), known as a full shared credit, for example 50/50 split or $0.25 each (Block 64). One embodiment of the present invention provides for sharing a portion of the purchase price of the coupon up to a predetermined limit, which can include the full purchase price of the coupon or in other words matched coupon company 12 or the web site 15 can receive up to 100 percent of the coupon price. The predetermined limit may be a portion of the company's monthly subscription fee up to the entire subscription fee. Another embodiment of the present invention may have no limit to the shared portion, thereby making web site 15 a profit center for company 12. After the debiting of customer's account and crediting of matched coupon company's and web site's account, the purchased coupons are sent or transmitted to customer 14 as disclosed above (Block 66). The coupon purchasing session is terminated (Block 68) once the purchased coupons are sent (e.g., U.S. Postal Service or other courier services like UPS or Federal Express) or otherwise transmitted (e.g., email or text message) to customer 14. Another embodiment of the present invention the coupon is free and does not require the coupon to be purchased, and therefore there is no revenue sharing feature to that embodiment. Another embodiment of the present invention has no revenue sharing feature even if a coupon is purchased, meaning that web site 15 receives 100 percent of the purchase price of the coupon.

Customer 14 redemption of the coupon to the matched coupon company 12 is not required for crediting the web site account with the purchase price of the matched coupon less an applied shared payable (if any) allocated to the matched coupon company 12, and crediting the matched coupon company payment account with the applied shared credit (if any). Requirements to share the coupon purchase price between the web site 15 and the matched coupon company 12 is that sharing (if any) be done after the step of debiting the customer payment account and prior to the coupon being redeemed by the customer 14 from the matched coupon company 12. The web site account and the matched coupon customer account will be credited the agreed portion of the purchase price of the coupon prior to sending the coupon to the customer 14.

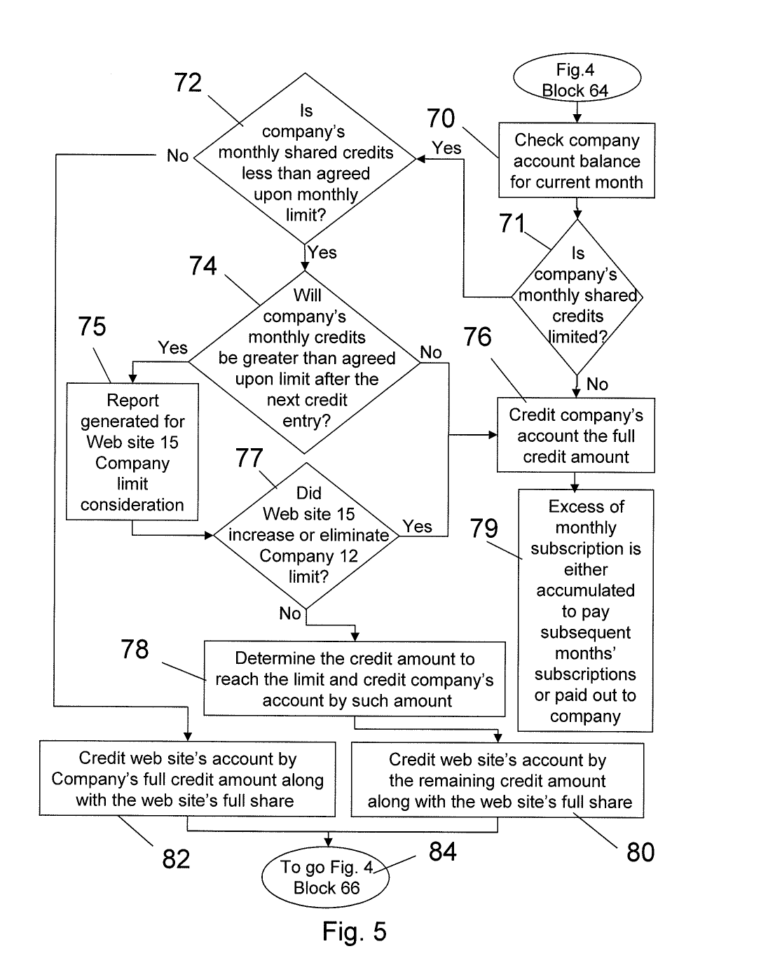

Now turning to FIG. 5 illustrating a flow diagram of the company account crediting process according to one embodiment of the present invention. Web site 15 checks the current month's account balance for company 14 (Block 70). The system will determine whether the company's shared credit of the revenue from the sales of coupons is limited (Block 71). Depending on terms and conditions agreed upon by the web site 15 and the company 12, for example if there is no limit, then the company's account is credited its full shared credit (Block 76). If the credit of its full share exceeds the next month's subscription, then the excess is either accumulated to pay subsequent months' subscriptions or paid out in the form of cash to company 12 (Block 79). If there is a limit to the company's share of the revenue from the sales of coupons, the system will determine whether the monthly credits are less than the agreed upon monthly limit (if any) discussed above (Block 72). If the company's account has been credited to an amount equal the limit, then the full shared credit amount of the company's share portion is credited to the web site's account along with the web site's full share (Block 82) and the session continues (Block 84) back to FIG. 4, Block 66, to send the coupons to the customer after crediting the company's account and/or the web site's account. If the company's monthly credits is less than the agreed upon limit, then the system determines whether the company's monthly credit is greater than the agreed upon limit after crediting the next full shared credit (Block 74). If the company's monthly credit is less than the agreed upon limit after the next shared credit entry, then the company's account is credited its full shared credit (Block 76). If the company's monthly credit is more than the agreed upon limit after the next shared credit entry, then the system will automatically generate a report for web site 15 to review company limit (Block 75) and determine whether to increase the limit, eliminate the limit, or not change the limit (Block 77). If the decision is to not change the limit, then the system will determine the shared credit amount to reach the limit and credit the company's account by that amount or the applied shared credit (Block 78). The applied shared credit is the difference between the monthly credit limit and the current accumulated monthly shared credit. The web site's account will by credited the remaining portion of the company's full shared credit (full shared credit minus the applied shared credit) along with the web site's full shared credit (Block 80) and the session is terminated (Block 84).

As mentioned above, as customers 14 purchase coupons from web site 15, web site 15 can give back a portion of the revenue (known as shared revenue) to the company 12 (also referred to as the matched coupon company) that posted the coupon. The company's share is credited back into the company's account that posted the coupon to cover the monthly flat fee for the following month. If company 12 sells enough coupons, then the flat fee subscription could be completely covered. In the event the percentage paid back to company exceeds the next month's flat fee amount, then there are two possibilities: (i) web site 15 keeps the money over and above the monthly fee, or (ii) web site 15 can apply the credit to future months subscriptions or distribute the excess to the company turning this business relationship into a profit center.

Below are possible scenarios of the distribution of revenue from the sale of coupons. The examples are not intended to limit the present invention to any particular subscription fees, revenue sharing percentages or fixed amounts, or coupon purchase prices.

First Fact Pattern:

1. Company 12 pays a flat fee monthly subscription of $50.00.

2. Web site 15 agrees to share or give back to company 12 20% (80/20 split) of the $0.25 coupon purchase or $0.05 for each coupon purchased under certain conditions.

Scenario One: Company's share limit is not reached illustrated in FIG. 5.

1. Company's monthly shared credit limit is $50.00 (Block 71).

2. On the 15th day of the current month, company 12 has sold 500 coupons during the current month and company 12 has been credited $25.00 as its current accumulated monthly shared credit.

3. Company 12 sells 20 coupons on 16th day of the current month for a potential shared credit of $1.00 (20 coupons time $0.25 per coupon times 0.2).

4. The company's current accumulated monthly shared credit ($25.00) is less than the company's monthly shared credit limit is 550.00 (Block 72).

5. The addition of the new shared credit ($1.00) to the company's current accumulated monthly shared credit ($25.00) will result in the company's new accumulated monthly shared credit ($26.00) being less than the company's monthly shared credit limit ($50.00) (Block 74), so the new shared credit ($1.00) can be credited to the company's account (Block 76).

Scenario Two: Company's shared credit limit is reached after credit of the next shared credit illustrated in FIG. 5.

1. Company's monthly shared credit limit is $50.00 (Block 71).

2. On the 15th day of the current month, company has sold 500 coupons during the current month and has been credited $25.00 as its current monthly shared credit.

3. The company's current monthly shared credit ($25.00) is less than the company's monthly credit shared limit is $50.00 (Block 72) for a remaining monthly credit shared limit of $25.00.

4. Company 12 sells 500 coupons on 16th day of the current month for a potential shared credit of $25.00 (500 coupons time $0.25 per coupon times 0.2).

5. The addition of the new shared credit ($25.00) to the company's current accumulated monthly shared credit ($25.00) will result in the company's new accumulated monthly shared credit ($50.00) being equal to the company's monthly shared credit limit ($50.00) (Block 74), so the new shared credit ($25.00) can be credited to the company's account (Block 76).

Scenario Three: Company's shared credit limit will be reached by partial portion of company's shared credit illustrated in FIG. 5.

1. Company's monthly credit shared limit is $50.00 (Block 71).

2. On the 15th day of the current month, company 12 has sold 500 coupons during the current month and company 12 has been credited $25.00 as its current accumulated monthly shared credit.

3. The company's current accumulated monthly shared credit ($25.00) is less than the company's monthly shared credit limit is $50.00 (Block 72) for a remaining monthly credit shared limit of $25.00.

4. Company 12 sells 1000 coupons on 16th day of the current month for a potential shared credit of $50.00 (1000 coupons time $0.25 per coupon times 0.2).

5. The addition of the new shared credit ($50.00) to the company's current accumulated monthly shared credit ($25.00) will result in the company's new accumulated monthly shared credit ($75.00) being greater than the company's monthly credit shared credit limit ($50.00) (Block 74), so a partial shared credit of $25.00 is added to the $25.00 of the company's current accumulated monthly shared credit making the company's new accumulated monthly shared credit $50.00 (Block 78). The partial shared credit of $25.00 is credited to the company's account (Block 78) and the remaining $25.00 shared credit is credited to the web site's account (Block 80).

Scenario Four: There is no limit to Company's share of the revenue from the sales of coupons illustrated in FIG. 5.

1. Company's monthly shared credit limit is infinite (Block 71).

2. On the 15th day of the current month, company 12 has sold 500 coupons during the current month and company 12 has been credited $25.00 as its current monthly shared credit.

3. Company 12 sells 1000 coupons on 16th day of the current month for a potential shared credit of $50.00 (1000 coupons time $0.25 per coupon times 0.2).

4. The new shared credit ($50.00) added to the company's current monthly shared credit ($25.00) will result in the company's new accumulated monthly shared credit ($75.00), which is $25.00 greater than the company's flat fee monthly subscription of $50.00. The partial shared credit of $25.00 is credited to the company's account (Block 76), and the remaining $25.00 shared credit (which is in excess of the next month's subscription) is either accumulated to pay subsequent month's subscription or the web site 15 can send company 12 is check or other financial instrument for $25.00 (Block 79).

Scenario Five: Company's share limit is reached before credit of the next shared credit illustrated in FIG. 5.

1. Company's monthly shared credit limit is $50.00 (Block 71).

2. On the 15th day of the current month, company has sold 1000 coupons during the current month and has been credited $50.00 as its current monthly shared credit.

3. Company 12 sells 1000 coupons on 16th day of the current month for a potential shared credit of $50.00 (1000 coupons time $0.25 per coupon times 0.2).

4. The company's current accumulated monthly shared credit ($50.00) is not less than the company's monthly shared credit limit of $50.00 (Block 72).

5. The entire or full company shared credit ($50.00) is credited to the web site's account (Block 82).

Second Fact Pattern:

1. Company 12 pays a flat fee monthly subscription of $50.00.

2. Web site 15 does not share revenue with Company 12.

Scenario: Entire purchase price of coupon is credited to web site account as illustrated in FIG. 4.

1. Customer 14 buys (4) coupons for Company A's product or service at $0.25 per coupon for a total of $1.00.

2. Customer's account is debited $1.00. (Block 62)

3. Web site's account is credited $1.00. (Block 63)

4. Web site 15 sends or transmits the (4) coupons to Customer 14.

### (Block 66)

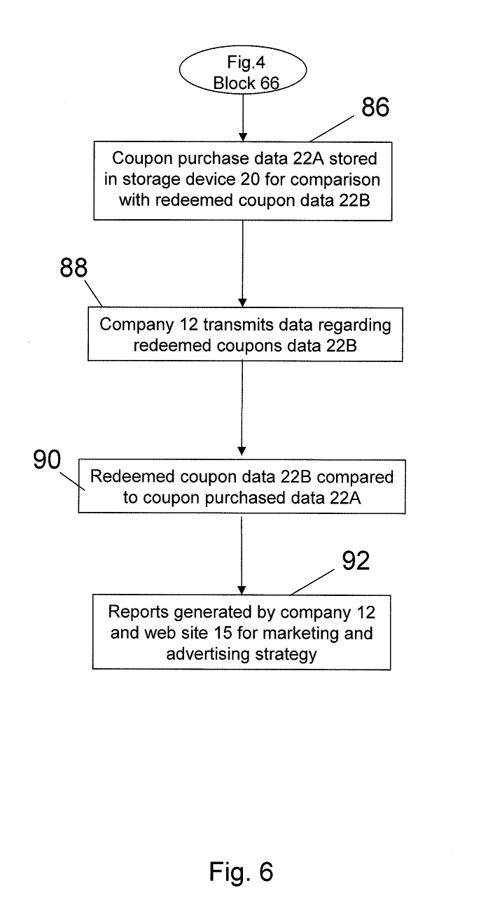

Now turning to FIG. 6 illustrating a flow diagram of the logic process to analyze purchased and redeemed coupons according to one embodiment of the present invention. The system stores coupon purchase data 22A (see FIG. 1) in storage device 20 (see FIG. 1) for comparison with redeemed coupon data 22B (see FIG. 1) (FIG. 6, Block 86). Company 12 transmits data regarding redeemed coupons 22B to the system for storage device 20 (FIG. 6, Block 88). System logic compares the redeemed coupon data 22A with the coupon purchase data 22B. Reports 23 (see FIG. 1) can be generated by web site 15 and companies 12 for marketing and advertising strategy (FIG. 6, Block 92). Providing these reports enhance value of the web site 15 and create more business opportunities for web site 15 and companies 12. FIG. 6,

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. An electronic coupon system comprising the steps of:
providing a web site operated by a web site host, wherein the web site comprises a data base and an account;
registering a customer on the web site and storing customer information on the data base, wherein the customer information comprises (i) a customer preferred listing of items including at least one item, and (ii) a payment account;
registering a plurality of coupon companies on the web site and storing information of each coupon company of the plurality of coupon companies on the data base, wherein the coupon company information comprises (i) posted coupons for items, and (ii) a payment account;
matching the at least one item of the preferred listing of items of the customer with posted coupons for items by the plurality of coupon companies;
receiving an order from the customer to purchase a matched coupon;
debiting the customer payment account by a purchase price of the matched coupon;
crediting the web site account with the purchase price of the matched coupon less an applied shared payable to the matched coupon company after the step of debiting the customer payment account and prior to a step of sending the matched coupon to the customer;
crediting the matched coupon company payment account with the applied shared credit after the step of debiting the customer payment account and prior to the step of sending the matched coupon to the customer; and
sending the matched coupon to the customer.

2. The system according to claim 1, wherein the applied shared credit is a full shared credit, wherein the full shared credit is an agreed upon portion of the purchase price of the matched coupon.

3. The system according to claim 1, wherein the applied shared credit is less than a full shared credit, wherein the full shared credit is an agreed upon portion of the purchase price of the matched coupon.

4. The system according to claim 1, wherein the applied shared credit is zero.

5. The system according to claim 1, wherein the step of registering the plurality of companies comprises the step of paying a monthly subscription fee.

6. The system according to claim 1, wherein the step of crediting the matched coupon company payment account with the applied shared credit further comprises evaluating the matched coupon company payment account to determine whether the matched coupon company has a monthly shared credit limit.

7. The system according to claim 6, wherein the step of evaluating further comprises the step of determining whether a current accumulated monthly shared credit of the matched coupon company is less than the monthly shared credit limit.

8. The system according to claim 7, wherein the step of evaluating further comprises the step of determining whether a new accumulated monthly shared credit is greater than the monthly shared credit limit if the current accumulated monthly shared credit is less than the monthly shared credit limit, wherein the new accumulated monthly shared credit is defined by adding a full shared credit to the current accumulated monthly shared credit, wherein the full shared credit is an agreed upon portion of the purchase price of the matched coupon.

9. The system according to claim 8, wherein the step of evaluating further comprises the step of automatically generating a report for limit evaluation if the new accumulated monthly shared credit is greater than the monthly shared credit limit.

10. The system according to claim 9, wherein the step of evaluating further comprises the step of increasing the limit.

11. The system according to claim 9, wherein the step of evaluating further comprises the step of eliminating the limit.

12. The system according to claim 9, wherein the step of evaluating further comprises the step of not changing the limit.

13. The system according to claim 12, wherein the step of evaluating further comprises the step of determining the applied shared credit by calculating the difference between the monthly shared credit limit and the current accumulated shared credit of the matched coupon company if the new accumulated monthly shared credit is greater than the monthly shared credit limit.

14. The system according to claim 13, wherein the step of evaluating further comprises the step of retaining an excess amount by the web site host by calculating the difference between the full shared credit and the applied credit.

15. The system according to claim 7, wherein the step of evaluating further comprises the step of retaining a full shared credit of the matched coupon company by the web site host if the current accumulated monthly shared credit is equal to the monthly shared credit limit, wherein the full shared credit is an agreed upon portion of the purchase price of the matched coupon.

16. The system according to claim 8, wherein the applied shared credit is the full shared credit if the new accumulated monthly shared credit is not greater than the monthly shared credit limit.

17. The system according to claim 5, further comprising the step of reducing the monthly subscription fee of a subsequent month by the amount of the applied shared credit.

18. The system according to claim 17, further comprising the step of paying the matched coupon company an amount that exceeds the monthly subscription fee of the subsequent month.

19. The system according to claim 5, wherein the step of registering the plurality of companies comprises the step of setting a coupon posting limit based on the monthly subscription fee.

20. The system according to claim 19, wherein the step of registering the plurality of companies comprises the step of allowing the company only deletions and modifications of existing coupons when the coupon posting limit is reached.
